(19) United States
(12) Patent Application Publication
(10) Pub. No.: US 2010/0288796 A1
(43) Pub. Date: Nov. 18, 2010

(54) VALVE SYSTEM ASSEMBLY

(75) Inventor: Paul Gaudron, Stratford, CT (US)

Correspondence Address: CANTOR COLBURN LLP, 20 Church Street, 22nd Floor, Hartford, CT, 06103, US

(73) Assignee: POWERS FASTENERS, INC., Brewster, NY (US)

(21) Appl. No.: 12/465,761

(22) Filed: May 14, 2009

(51) Int. Cl. B65D 88/54; F16K 21/00

(52) U.S. Cl. 222/402.1; 251/149

(57) ABSTRACT

Disclosed is a valve assembly for a fluid dispenser including a valve body and a valve stem slidably located in the valve body. The valve stem has at least one exit hole located at a tip of the valve stem. A valve stem adapter is located at the tip of the valve stem and affixed thereto. The valve stem adapter includes at least one adapter exit hole to allow exit of a dispensible fluid from the valve assembly. Further disclosed is a dispenser for a fluid including a cannister, an inner bag for dispensible fluid located inside of the cannister, and a valve assembly including a valve stem adapter is located at a tip of a valve stem and affixed thereto. The valve stem adapter includes at least one adapter exit hole to allow exit of a dispensible fluid from the valve assembly.

### BACKGROUND OF THE INVENTION

The subject matter disclosed herein relates to dispensers for fluid. More particularly, the subject matter disclosed herein relates to valve systems for fluid dispensers.

One example of such a dispenser is for a hydrocarbon fuel, which includes an outer cannister containing a typically organic pressurized propellant, an inner bag containing the dispensible fluid, and a normally closed valve enabling the dispensible fluid to be controllably dispensed from the inner bag. The valve assembly is typically disposed in a cannister cap and is fixed thereto. The valve is operated by depressing a valve stem into a valve body in which the valve stem is slidably located. When the valve stem is depressed, the dispensible fluid is urged from the inner bag through a valve body of the valve and out through one or more orifices in the valve stem, which are typically located on an end surface of the valve stem.

### BRIEF DESCRIPTION OF THE INVENTION

According to one aspect of the invention, a valve assembly for a fluid dispenser includes a valve body and a valve stem slidably located in the valve body. The valve stem has at least one exit hole located at a tip of the valve stem. A valve stem adapter is located at the tip of the valve stem and affixed thereto. The valve stem adapter includes at least one adapter exit hole to allow exit of a dispensible fluid from the valve assembly.

According to another aspect of the invention, a dispenser for a fluid includes a cannister, an inner bag for dispensible fluid located inside of the cannister, and a valve assembly extending through the cannister in flow communication with the inner bag. The valve assembly includes a valve body and a valve stem slidably located in the valve body. The valve stem has at least one exit hole located at a tip of the valve stem. A valve stem adapter is located at the tip of the valve stem and affixed thereto. The valve stem adapter includes at least one adapter exit hole to allow exit of a dispensible fluid from the valve assembly.

These and other advantages and features will become more apparent from the following description taken in conjunction with the drawings.

### BRIEF DESCRIPTION OF THE DRAWING

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is a partial view of an embodiment of a dispenser for dispensible fluid; and

FIG. 2 a cross-sectional view of an embodiment of a valve assembly.

The detailed description explains embodiments of the invention, together with advantages and features, by way of example with reference to the drawings.

### DETAILED DESCRIPTION OF THE INVENTION

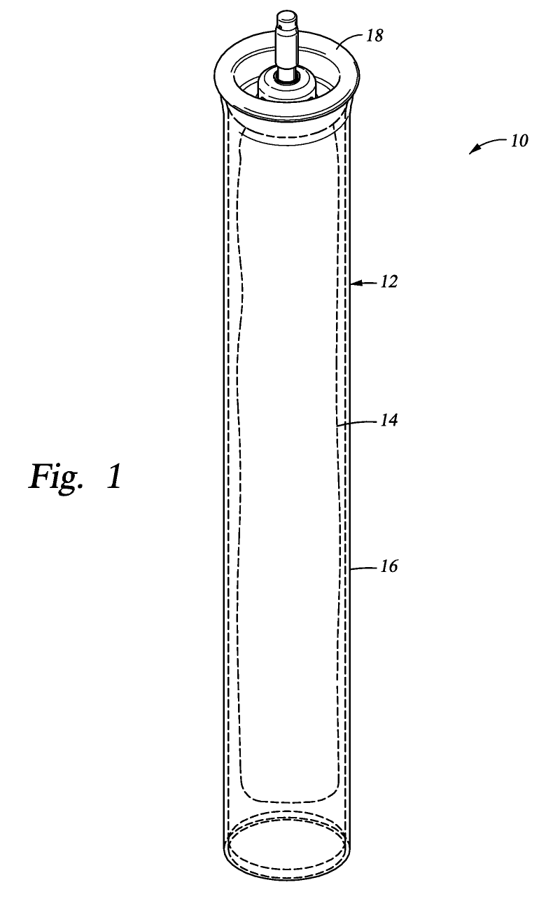

Shown in FIG. 1 is an embodiment of a dispenser 10 for a dispensible fluid. The dispenser 10 includes an outer cannister 12 and an inner bag 14 disposed therein. A volume of propellant is disposed in the outer cannister 12 and a volume of the dispensible fluid is disposed in the inner bag 14. The outer cannister 12 includes a body 16 and a cap 18 secured to the body 16.

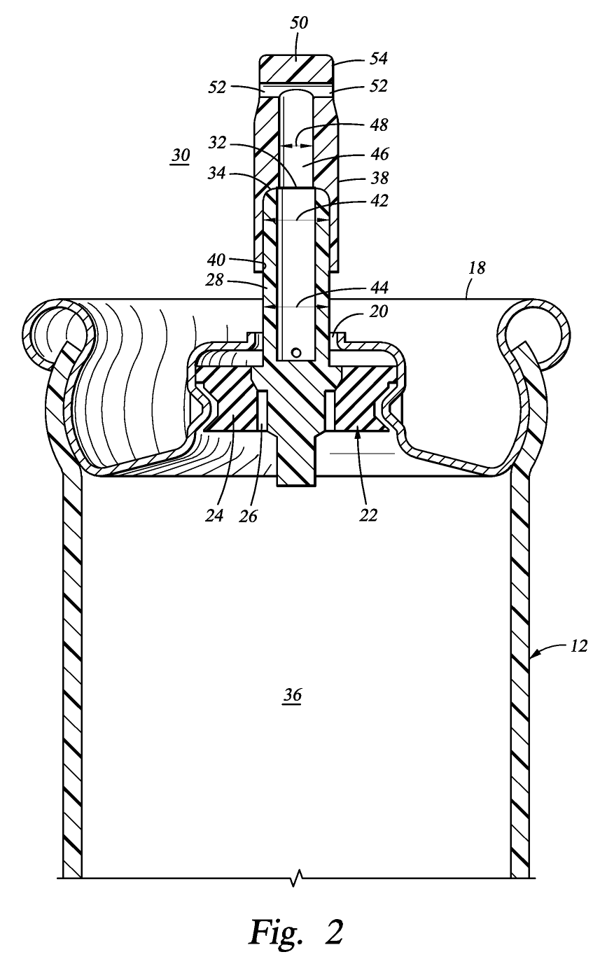

Referring now to FIG. 2, the cap 18 includes at least one cap opening 20 in which a valve assembly 22 is disposed. The valve assembly 22 includes a valve body 24 which in some embodiments is affixed to the cap 18. The valve body 24 has an annular cross-section including a valve body opening 26 in which a valve stem 28 is disposed. The valve stem 28 extends from the valve body opening 26 toward an exterior 30 of the canister 12. The valve stem 28 includes one or more exit holes 32, which in some embodiments are disposed at a valve stem tip 34. The valve assembly 22 is configured such that when the valve stem 28 is depressed toward an interior 36 of the cannister 12, the dispensible fluid is able to pass through the valve body 24 and the valve stem 28, exiting through the one or more exit holes 32.

The valve assembly 22 includes a valve stem adapter 38 disposed at the valve stem tip 34. The valve stem adapter 38 has an annular open end 40 with a diameter 42 larger than a valve stem diameter 44 so the valve stem adapter 38 fits over the valve stem 28. An adapter channel 46, which in some embodiments has a channel diameter 48 smaller than the diameter 42, extends from the open end 42 toward an adapter tip 50 of the valve stem adapter 38. In some embodiments, the valve stem adapter 38 includes one or more adapter exit holes 52 through which the dispensible fluid flowing from the exit holes 32 in the valve stem tip 34 passes to exit the valve assembly 22. In some embodiments, the adapter exit holes 52 extend in a substantially radial direction from the adapter channel 46, through a sidewall 54 of the valve stem adapter 38.

In some embodiments, the valve stem adapter 38 is formed from a plastic material, for example, acetal, but the utilization of other materials is contemplated within the present scope. The valve stem adapter 38 is secured to the valve stem 28 to prevent leakage of the dispensible fluid therebetween. The valve stem adapter 38 may be secured by, for example, ultrasonic welding, or by other suitable mean such as a press fit or by an adhesive.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A valve assembly for a fluid dispenser comprising:
a valve body;
a valve stem moveably disposed in the valve body, the valve stem having at least one exit hole disposed at a tip of the valve stem; and
a valve stem adapter disposed at the tip of the valve stem and welded thereto, the valve stem adapter including at least one adapter exit hole to allow exit of a dispensible fluid from the valve assembly.

2. The valve assembly of claim 1 wherein the valve stem adapter includes an open end which is disposed over the tip of the valve stem.

3. The valve assembly of claim 1 wherein the valve stem adapter includes at least one adapter channel extending from the open end toward an adapter tip.

4. The valve assembly of claim 1 wherein the valve stem adapter includes one or more adapter exit holes for dispensing the dispensible fluid.

5. The valve assembly of claim 4 wherein the one or more adapter holes extend through a sidewall of the valve stem adapter.

6. The valve assembly of claim 5 wherein the one or more adapter holes extend in a substantially radial direction relative to a central axis of the valve stem adapter.

7. The valve assembly of claim 1 wherein the valve stem adapter is formed from a plastic material.

8. The valve assembly of claim 1 wherein the valve stem adapter is affixed to the valve stem by ultrasonic welding.

9. A dispenser for a fluid comprising:
a cannister;
an inner bag for dispensible fluid disposed inside of the cannister; and
a valve assembly extending through the cannister in flow communication with the inner bag, the valve assembly comprising:
a valve body;
a valve stem moveably disposed in the valve body, the valve stem having at least one exit hole disposed at a tip of the valve stem; and
a valve stem adapter disposed at the tip of the valve stem and welded thereto, the valve stem adapter including at least one adapter exit hole to allow exit of a dispensible fluid from the valve assembly.

10. The dispenser of claim 9 wherein the valve assembly extends through a cap of the cannister.

11. The dispenser of claim 9 wherein the valve stem adapter includes an open end which is disposed over the tip of the valve stem.

12. The dispenser of claim 9 wherein the valve stem adapter includes at least one adapter channel extending from the open end toward an adapter tip.

13. The dispenser of claim 9 wherein the valve stem adapter includes one or more adapter exit holes for dispensing the dispensible fluid.

14. The dispenser of claim 13 wherein the one or more adapter holes extend through a sidewall of the valve stem adapter.

15. The dispenser of claim 14 wherein the one or more adapter holes extend in a substantially radial direction relative to a central axis of the valve stem adapter.

16. The dispenser of claim 9 wherein the valve stem adapter is formed from a plastic material.

17. The dispenser of claim 9 wherein the valve stem adapter is affixed to the valve stem by ultrasonic welding.
